(19) United States
(12) Patent Application Publication
(10) Pub. No.: US 2013/0110710 A1
(43) Pub. Date: May 2, 2013

(54) SYSTEMS, METHODS AND COMPUTER PROGRAM PRODUCTS FOR INCENTIVIZING EFFICIENT ACQUISITION OF PATENT RIGHTS

(71) Applicant: Article One Partners Holdings, (US)

(72) Inventor: Cheryl Anne Milone, New York, NY (US)

(73) Assignee: Article One Partners Holdings

(21) Appl. No.: 13/666,720

(22) Filed: Nov. 1, 2012

Related U.S. Application Data
(60) Provisional application No. 61/554,229, filed on Nov. 1, 2011.

(51) Int. Cl. G06Q 20/22; G06Q 50/18

(52) U.S. Cl. 705/39; 705/310

(57) ABSTRACT

Embodiments of the present disclosure include systems and methods of locating patent assets. Embodiments include requesting information related to a technology subject matter. The request can be sent to a research community that returns crowd-sourced results, e.g., patent assets. The patent assets can be sorted, weighted, and analyzed for quality. One method of assessing quality is to compare the crowd-sourced patent assets to patent assets obtained through other means, such as through a semantic search. Another method includes weighting results using various criteria to prioritize patent assets.

### PRIORITY CLAIM

This application claims the benefit of priority under 35 U.S.C. §119(e) to U.S. Provisional Patent Application Ser. No. 61/554,229, filed Nov. 1, 2011, which is incorporated herein in its entirety.

### FIELD

Example embodiments pertain to the field of the acquisition of patent assets or patent purchases.

### BACKGROUND

In recent years, there has been an increase in the acquisition of patent assets by a number of stakeholders in the patent industry, including practicing entity companies seeking to build their portfolios, acquire portfolios for defensive purposes or to identify high-quality companies based on the identification of strong patent assets. Patent assets can include invention disclosures, publications, applications, patents, patent portfolios, or other patent-related information. Companies that do not practice the patents, i.e., do not make or manufacture products or provide services (also called non-practicing entities (NPEs)) also acquire patent assets. Acquirers of patent assets include individual inventors, practicing entities, NPEs (within or outside of a litigation context), aggregators, organizations that control or have access to patent assets, or any assignee of patent assets.

As of historical levels of patent purchase amounts in 2011, there is a demonstrated trend in industry of acquiring patent assets. The acquisition and selling or licensing of patent assets has historically been implemented in a highly developed patent brokerage market, with buyers and sellers participating directly as well as through brokers, aggregators and other industry participants, including lawyers and business consultants. Industry focuses on identifying valuable patent assets and efficiently acquiring them. Particularly, as the number of buyers competing for valuable patent assets has increased with the increasing trend of acquisition, and the level of valuation being placed on patent assets, the monetization of patent assets by patent-asset owners is an attractive revenue source. Due to the number of acquirers and stakeholders in the industry, acquirers can receive greater value by approaching patent-asset owners who have not been an easily identified target for acquisition and therefore have not been contacted by a large number of industry stakeholders, such as brokers or other industry acquirers. Where a patent-asset owner is approached by high profile or multiple industry stakeholders, the patent-asset owner is notified, based on the level of interest, of the patent asset's value and, therefore, potential acquirers face a situation with the valuation potentially being inflated by the level of interest presented to the patent-asset owner or source of acquisition. It is therefore in the interest of acquirers and brokers representing acquirers to seek unique sources of patent acquisition as well as source of identification. There is a transactional model problem, however, with the notion of additional industry stakeholders entering the field and seeking the same data at the same time that valuations overall are being inflated by the general rate of transactions in the patent industry.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof, which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment.

FIG. 2 illustrates an example method embodiment for locating patent assets.

FIG. 3 illustrates an exemplary embodiment of a request for information.

FIG. 4 illustrates a second example method embodiment for locating patent assets.

FIG. 5 illustrates results or patent assets according to one embodiment.

FIG. 6 is a block diagram of an exemplary system for carrying out the processes of the present disclosure.

### DETAILED DESCRIPTION

One embodiment includes a novel approach to identifying valuable patent assets by presenting to a global research community or subsets of large portfolios. The novel approach results in a more comprehensive list of potential patent assets by maximizing and efficiently identifying patent assets and patent portfolios. In an additional embodiment, a novel approach results in a hierarchical list of patent assets that can be assigned to categories, e.g., unlikely to be widely known as potential assets targeted by industry, versus patent assets that are likely well-known targets within the industry. Similar embodiments can identify patent assets in individual patent assets that that may be unique in contrast to industry knowledge. In another embodiment, the list of patent assets can include weighting the patent assets according to their relevance, where specific patent assets are identified multiple times, and therefore are identified as having a higher level of relevance. In yet additional embodiments, the results of identifying patent assets can include whether the patent-asset owner is amenable to selling the patent assets; whether the patent assets are owned by certain types of patent-asset owners in industry sectors (including industry sectors within the target industry sector or the target technology subject matter, or, in contrast, industry sectors that are not part of the target technology subject matter); whether the patent assets are owned by certain market valuation or industry sector companies, or other definitions of entities, such as universities, individual inventors, large practicing entities, NPEs etc.; or whether the patent assets identified can be commercialized within a predetermined period of time, including where technology subject matter is currently commercialized, will be commercialized within one year, two years, three-five years, or any combination of a time. That enables the patent acquirer to prioritize patent assets for acquisition.

Some embodiments include requests for patent assets that can be structured to support a semantic search of digitized databases, and artificial intelligence research of digitized databases. Expert networks can also perform organized searches using a formal methodology, where the expert networks can apply their own form of search. The patent assets that will be identified by this approach will likely have a large overlap. As a result, the patent asset owners have a high likelihood of receiving multiple inquiries about interest in the patent assets.

In one embodiment of the present disclosure, a target patent asset or technology subject matter is selected as a starting point to define patent assets of interest. Examples include a technology description, prior art, or a state-of-the-art landscape description. A request can then be prepared for patent assets (with or without non-patent literature). The request can include a description of one or more technologies. Where multiple technology descriptions are included, the description can identify whether the multiple technology descriptions are conjunctive, disjunctive, or in part conjunctive or disjunctive. The search need not be limited to search structure for digitized database use.

The request for identification of patent assets (with or without prior collections related to patent assets) can be given to a global research community of researchers, e.g., a crowd-sourced research community, via a host website. Results received from the research community can be gathered for analysis or comparison to additional results. The results can be gathered, for example, in a database and displayed on the host website privately or publicly in real-time as the crowd-sourced platform administrator receives them. In some embodiments, the host website will not display results until after the results are processed and analyzed to ensure that only the most relevant results are displayed.

Identified patent assets can be grouped according to weighting shown above alone or in combination with one or more other factors that can also be presented as part of the request. New factors, alone or in combination, can be added, such as the following: the results of identifying patent assets can include whether the patent-asset owner is amenable to selling the patent assets; whether the patent assets are owned by certain types of patent-asset owners in industry sectors (including industry sectors that are within the target industry sector of the target technology subject matter, or, in contrast, industry sectors which are not part of the target technology subject matter); whether the patent assets are owned by certain size companies, or other defines entities, such as universities, individual inventors, large practicing entities, NPEs etc.; or whether the patent assets identified can be commercialized within a predetermined period of time, including where technology subject matter is currently commercialized, will be commercialized within one year, two years, three-five years, or any combination of a time. This enables the patent acquirer to prioritize patent assets for acquisition.

From the baseline of requesting patent assets with or without passing the identification of additional data as set forth above, the resulting list of patent assets can be identified as patent assets based on knowledge within the research community, aggregating the creativity, background, subject matter expertise and/or empirical experience etc. of each research community member of the crowd.

The crowd-sourced patent list can be sorted by companies in the Fortune 500 versus companies in the Fortune 2000 or other segmentation of industry. Further segmentation can be applied to match additional areas of interest for potential acquirers.

Where the original patent-asset request does not include the additional data, additional communications can be made directly to the research community. The subsequent communications can request the additional data, and can request that the researcher determined whether the patent asset is potentially for sale, with or without the authority to contact the patent-asset owner. A patent asset may be potentially for sale if the patent-asset owner is in financial trouble base on information filed with the Security and Exchange Commission or other public information, if the patent-asset owner has sold other patent assets; if the patent-asset owner is an NPE; if the patent-asset owner is involved in patent litigation; if the patent asset is unrelated to the patent-asset owner's business; or a combination of these factors. Research community members may be compensated for the type and amount of information provided.

In some instances, it may be undesirable for the research community to contact the patent-asset owner because that could indicate to the patent-asset owner that the patent asset is valuable. One way to protect against the research community reaching out to patent-asset owners is to present that research community members who are compensated based on incentive to respond to the request will only be compensated if the patent-asset owner confirms that the research community member has not reached out to the patent-asset owner. This additional data can result in additional compensation for the researcher. A reward can be provided to the research community based on the highest quality. For example, in one embodiment, a patent asset with the largest overlap based on the technology description or patent asset identified in the request, and/or the number of patent assets and/or portfolio that match the technology description. In alterative embodiments, the research community member can receive additional compensation. For example, when the crowd-sourced platform administrator receives a commission from the sale of the patent asset, the commission can be shared with the research community member. A flat fee can also be paid to the first research community member that is the source of the first patent asset that is acquired by a sponsor of the study, so this can act as an additional incentive without a commission basis for the research community to identify patent assets, and the acquirer by paying a flat acquisition fee avoids having to provide information about the transaction amount.

Tiers of flat fee commissions also can be paid. For example, higher amounts can be paid for number of patent assets identified, quality of patent assets, duration of service in the research community, and other factors.

In alterative embodiments, the crowd-sourced platform administrator can identify technology descriptions of interest to the brokerage industry, can complete the searches to identify patent assets, can procure the patent assets, and can then license the collection to potential acquirers or other stakeholders in the industry. An auction process can also be applied to these collections, such as that described in U.S. Pat. No. 7,991,624, owned by Article One Partners Holdings, which is hereby incorporated by reference in its entirety.

The crowd-sourced patent asset list can also be compared to the list resulting from semantic or other search-engine approach. The differentiation between the lists can present a subset of patent assets where those patent assets that appear on the crowd-sourced list can be deemed more unique than patent assets appearing on a semantic search list. The crowd-sourced differentiations list can then be used for initial outreach to occur before the semantic search lists or overlapping lists in order to optimize the timeliness of outreach to patent-asset owners that had a reduced incidence of being contacted members of the industry.

The crowd-sourced patent asset list can also include an analysis of those patent assets identified by more than one research community member, thereby adding a weighting factor to the relevance of those patent assets. Those patent assets can then be prioritized for initial outreach, particularly when the patent assets also appear on the differentiated list in contrast to the semantic search engine list.

The crowd-sourced platform administrator can perform one or more of these functions to capture potentially a scope of commission levels. For example, the crowd-sourced platform administrator can provide the crowd-sourced differentiated list of patent assignees to a potential acquirer and receive a commission for the patent assets on the list, which can be used by the patent acquirer to acquire patent assets. The crowd-sourced platform administrator can conduct due diligence, outreach to patent-asset owners, and provide greater service by engaging in a strategic relationship with a third party to provide brokerage services to advance transactions to acquisition. The crowd-sourced platform administrator can then increased commissions. The commissions in either case can be shared in part or in whole with the research community. The crowd-sourced platform administrator can drive multiple commissions because of a single request presented to the research community, based on one or more identified parties that meet the requirements of the request. Where the management of providing the research community with commissions on individual patent acquisitions is difficult to manage, for example, due to the time, commissions can be paid before a request period completes. In one example, identification of patent assignees can take months, and may exceed the time period in which the research community agreed to be paid. In this case, the commissions can be at least partly included in profit-sharing to the research community, even where the the crowd-sourced results of a request have not yet been used. Where the list is sold to multiple potential acquirers, multiple rewards can be paid to the research community, akin to a royalty.

The crowd-sourced results can also include patent validity research as part of the initial request or as part of follow-up requests to researchers, where patent assets are deemed to be of high quality. In this way, the research community can be accessed for due diligence of the transaction. In this manner, the research community can also have a subsequent basis for receiving additional compensation, for example, the additional prior art collection can be the basis for a portion of the commission or further flat fee compensation. This request can also be made as part of the initial publicly available request.

The crowd-sourced platform administrator can present requests to its client base, the results of which can be licensed to clients. The results can be sold alone or in combination with a list of patent assets that is unlikely to have been identified in a semantic or other traditional search. The crowd-sourced platform administrator can also contact assignees or inventors to provide the added benefit or return on investment of optimizing the valuation based on more unique patent assignees who were less likely to have been contacted by industry stakeholders already. The crowd-sourced platform administrator can identify the patent assets and then auction off the first access to its clients. The crowd-sourced platform administrator can also purchased the patent assets and resell them to its client base.

The crowd-sourced requests can also set up a monitoring system for continuously monitoring new patent assets, which need the description in the request. A monitoring compensation structure can be set up where researchers receive compensation, for example, on a periodic basis such as quarterly, with or without commissions, and the ongoing identification of patent assets can be provided to clients, or monetized in the manners mentioned above as driven by the crowd-sourced platform administrator.

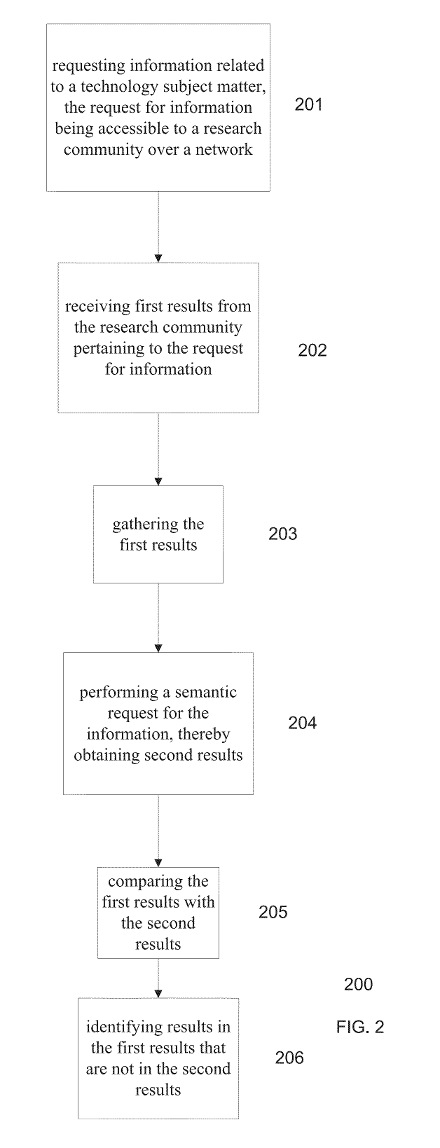

FIG. 2 illustrates an exemplary method embodiment 200 including making a request for information related to a technology subject matter, the request for information being accessible to a research community over a network (step 201). FIG. 2 also includes receiving first results, e.g., patent-assets or identification of the patent assets, from the research community pertaining to the request for information (step 202). Step 203 includes gathering the first results, which can occur in a database or any other short-term or long-term storage. The method can also include performing a semantic request for the information, thereby obtaining second results (step 204). Next, the method can include comparing the first results with the second results (step 205). Comparing the first result and second results can include identifying results in the first results that are not in the second results (step 206).

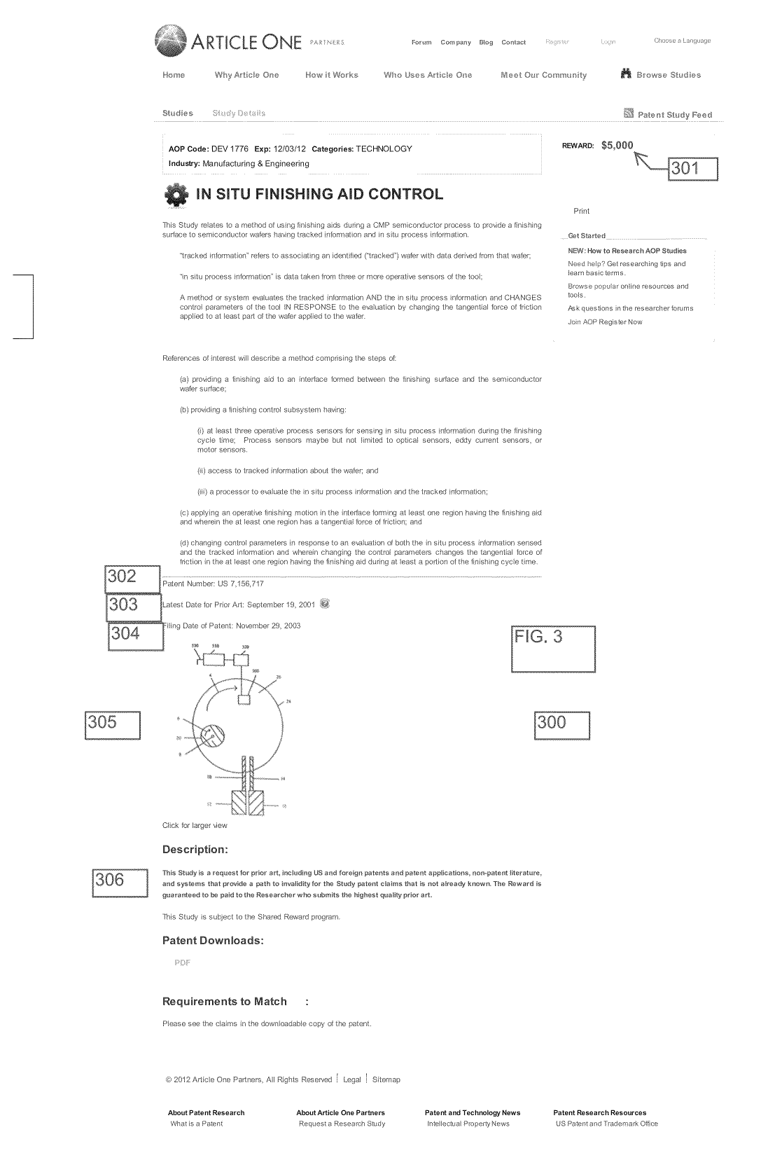

FIG. 3 illustrates an exemplary embodiment of a request for information 300. The request for information 300 can include a patent number 302, a date for prior art search purposes 303, a filing date 304, a FIG. 305, and a description 306. Additionally, embodiments can include a reward 301 for returning results. As discussed above, the reward 301 can be a flat fee or a commission dependent on any number of factors.

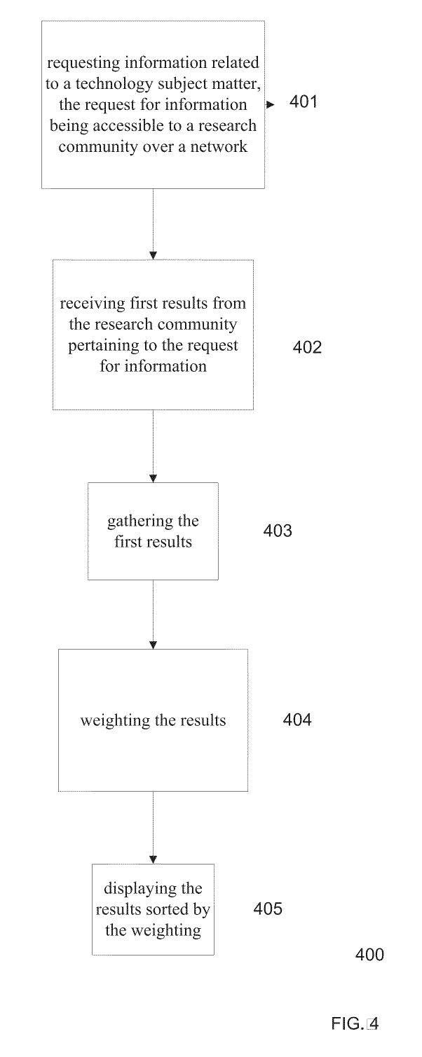

FIG. 4 illustrates a second exemplary method embodiment 400 including making a request for information accessible to a research community over a network (step 401). FIG. 4 also includes receiving first results from the research community pertaining to the request for information (step 402). Step 403 includes gathering the first results, which can occur in a database or any other short-term or long-term storage. The method can also include weighting the results (step 204), which the disclosure above describes in detail. Finally, the method 400 can include displaying the results sorted by weighting, which can allow for efficient review of the results (step 405).

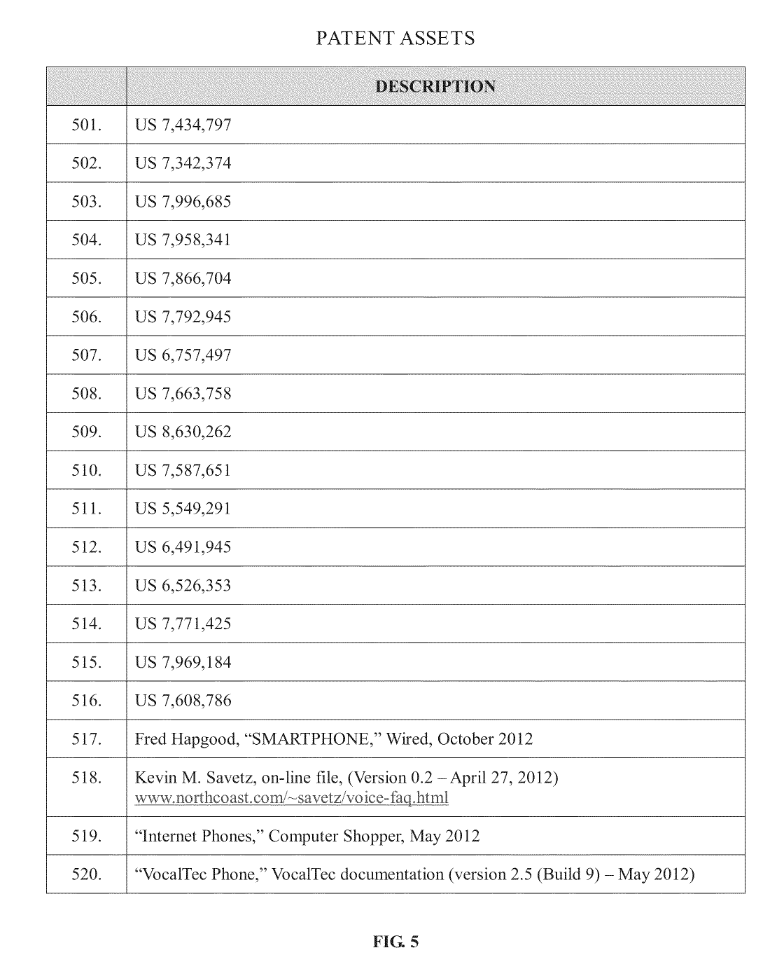

FIG. 5 illustrates results or patent assets according to an exemplary embodiment. Patent assets can be patents 501-516, invention disclosures that are less than one-year old 517-520. Other embodiments include additional patent assets as described in more detail above.

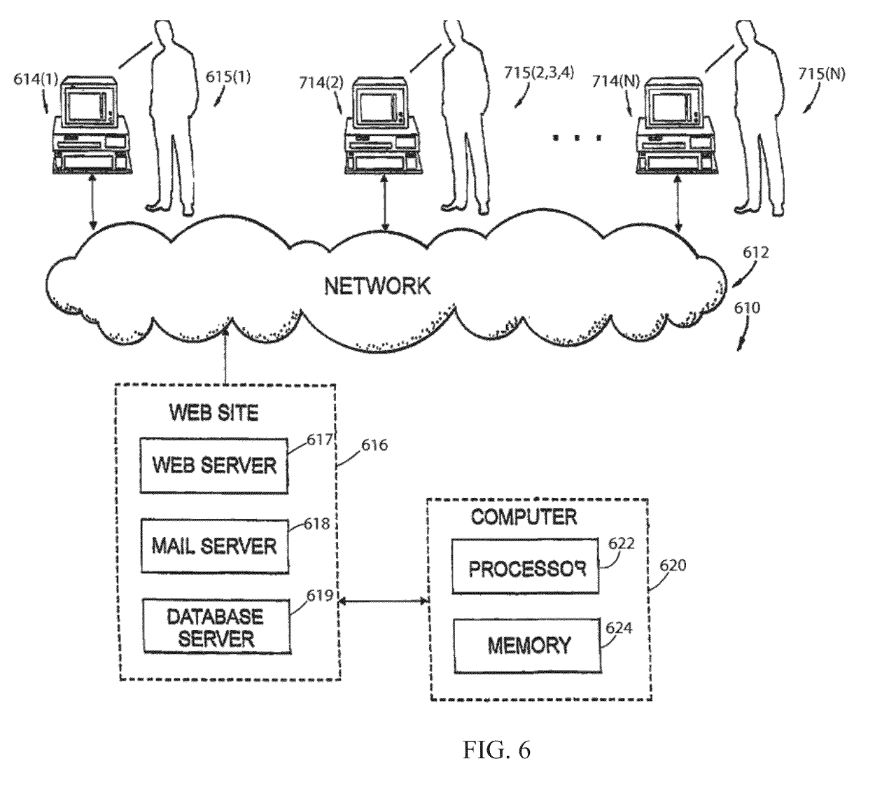

FIG. 6 illustrates an exemplary system 610 for requesting information. The system 610 for implementing the information exchange can be setup to maximize the distribution of the highest quality information most efficiently, e.g., by utilization of the Internet 612 network, including the Internet or any type of Intranet or other types of networks. This could be used internally in a company. Further, the system 610 can be organized to maximize the revenue streams to the crowd-sourced platform administrator of the host website 616, which operates web server 617, mail server 618 and database server 619 using for example computer 620 including processor 622 and memory 624. Research community members are shown as 615(1) to 615(N) connected through computers 614(1) to 614(N), or alternative communication means to system 610. Research community members, for example 715(1) to 715(N), to whom queries are put in example embodiments could, in an exemplary embodiment, also be connected to the network 612 through computers 614(1) to 614(N). Each research community member could each have such a connection or an alternative means of communication with system 610. The use of the term organization disclosed herein does not limit the scope of example embodiments as this term can take a variety of forms. For example, queries could be mailed to experts or published in newspapers instead of or in addition to publication over the network 610 or Internet. Similarly, the results of a search may be published by mail or the press may publish the results. Further, broadcast media may be used to post queries to be searched and to disclose the results of the search. However, with broad unselected publication of the search request, non-experts may chose to submit answers. The system organizer may chose in certain circumstances to reward only answers from experts or to reward anyone submitting a valid answer.

FIG. 6 illustrates an example of an overall system 610 in which embodiments disclosed herein can be used. System b610 includes a network 612, such as the Internet, Intranet, or any other network known or later developed which connects computers. Computers 614 are connected to the network 612. Computers 614 are shown as 614(1), 614(2) to 614(N) and they can be operated by users 615(1), 715(2,3,4) to 715(N). N as used herein denotes an unlimited quantity of the object to which it relates and the value of N can change for each object. Therefore, any number of computers 614, 714 can be connected to network 612 and each computer 614, 714 can be operated by any number of users 615, 715.

Also connected to network 612 is web site 616. Web site 616 posts one or multiple requests for information.

Since web site 616 is also connected to network 612, users 615, 715 can access web site 616 from any computer 614, 714 throughout the world having appropriate network access and software, such as a web browser. In alternative embodiments, users 615, 715 can gain access to web site 616 or the business supporting it, including web site 616 employees, from other mechanisms, such as e-mail outside web site 616, facsimile or telephone.

Various hardware devices can operate web site 616. Such devices are a design choice which are well known to those of ordinary skill in the art and do not limit this invention. For example, a web server 617 can service users 615, 715 of web site 616, including storing and operating the applications, screen displays and images for web site 616 as well as the sub-systems for operating web site 616, etc. Also, a database server 619 can store databases requests, users 615, 715 responses, rewards and all other programs and data to support web site 616, etc. A mail server 618 also can be included in order to communicate e-mail between users 615, 715 and web site 616. Additional web servers, database servers and mail servers can be added to support an increased load on web site 616. Also, web site 616 can be generated, operated, updated and administered by a computer 620 that connects to servers 617, 618 and 619 supporting web site 616. Computer 620 operates based on a processor 622 under the control of a program. For ease of reference, such processing will hereinafter be indicated by the use of the term “Computer 620.” Computer 620 also includes memory 624 (including one or more storage elements, such as a hard disk or RAM; additional memory can be added). Computer 620, processor 622 and memory 624 are used to access servers 617, 618 and 619 and run the software necessary for generating and maintaining web site 616. Computer 620 can also process communications between user 615, 715 and employees of web site 616, such as, for example, e-mail using mail server 618, facsimile or telephone, etc. In addition, computer 620 can be implemented in one or more computers such as, for example, computers 614, 714. Other alternative communications between users 615, 715 and the employees of web site 616 such as, for example, postal mail, facsimile, outside computer 620, etc. are also contemplated. In addition, many other hardware configurations known in the art can be used.

It is understood that the application of the disclosed system 610 complies strictly with all United States and international laws involving the dissemination of information in general and financial information in particular. The system can implement specific processes to prevent the distribution of insider information, confidential information or information limited by contract to a third party vis-a-vis experts.

Research community members can be qualified for participation based on executing a contract not to disclose any illegal, confidential or third-party-owned information or information which they otherwise are encumbered from disclosing (hereinafter, non-public information). In one embodiment, a focus for qualifying research community members can be those professionals who owe a separate ethical or professional duty not to divulge any non-public information. For issues that relate to the financial environment, any additional processes available as part of the best practices on Wall Street can be employed to address this issue. Institutional experts can be required to implement an internal compliance process for their member or employee experts before the information can be submitted to website 616 for processing. The research community members can be cleared for participation in the information exchange based on their agreement not to divulge illegal information or information that is illegal to divulge.

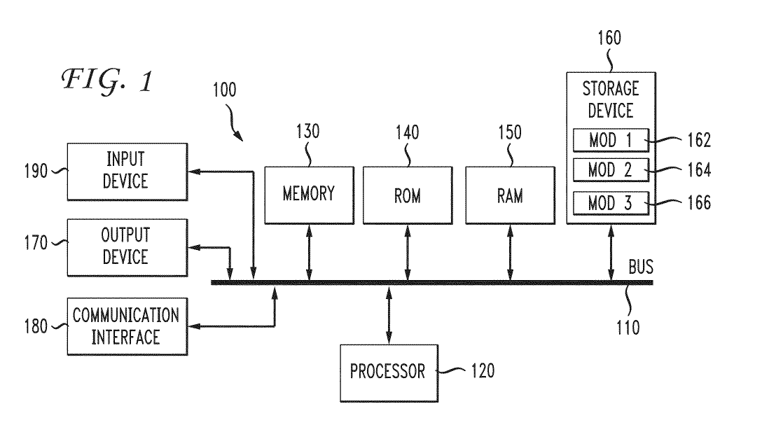

These variations shall be discussed herein as the various embodiments are set forth. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache of high-speed memory connected directly with, in close proximity to, or integrated as part of the processor 120. The system 100 copies data from the memory 130 and/or the storage device 160 to the cache for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example, the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general-purpose DSP circuit, may also be provided.

The logical operations of the various embodiments are implemented as: (1) a sequence of computer-implemented steps, operations, or procedures running on a programmable circuit within a general use computer, (2) a sequence of computer-implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166, which are modules configured to control the processor 120. These modules may be stored on the storage device 160 and loaded into RAM 150 or memory 130 at runtime or may be stored as would be known in the art in other computer-readable memory locations.

Embodiments of the present disclosure may be implemented as instructions in non-transitory one or more electronically readable media, which when executed on a processor perform steps as described in detail above and recited by the claims below.

Unless otherwise specified, any of the features of the various embodiments described herein can be used in conjunction with features described in connection with any other embodiments disclosed. Accordingly, features described in connection with the various or specific embodiments are not to be construed as not suitable in connection with other embodiments disclosed herein unless such exclusivity is explicitly stated or implicit from the context.

The various embodiments described above are provided by way of illustration only and should not be construed to limit the scope of the disclosure. For example, the principles herein can be used to solve more effectively any number of research problems. Those skilled in the art will readily recognize various modifications and changes that may be made to the principles described herein without following the example embodiments and applications illustrated and described herein, and without departing from the spirit and scope of the disclosure.

I claim:

1. A method of locating patent assets comprising:
requesting, via a host website, information related to a technology subject matter, the request for information being accessible to a research community over a network;
receiving, via the host website, first results from the research community pertaining to the request for information;
gathering, via the host website, the first results;
performing, via one or more computers, a semantic request for the information, thereby obtaining second results;
comparing, via the one or more computers, the first results with the second results; and
identifying, via the one or more computers, results in the first results that are not in the second results.

2. The method of locating patent assets according to claim 1 further comprising paying a commission to one or more research community members based on a fee received by a crowd-sourced platform administrator.

3. The method of locating patent assets according to claim 1 further comprising paying a flat fee to one or more research community members based on when results were returned relative to other results.

4. The method of locating patent assets according to claim 1 further comprising:
requesting, via the host website, second information from the research community over the network.

5. The method of locating patent assets according to claim 4 further comprising paying a commission to one or more research community members based on receiving second results received in response to the second request for information.

6. The method of locating patent assets according to claim 4 further comprising paying a commission to one or more research community members based on the fee received by the crowd-sourced platform administrator.

7. The method of locating patent assets according to claim 4 further comprising paying a flat fee to one or more research community members based on when results were returned relative to other results.

8. The method of locating patent assets according to claim 6 or 7 further comprising paying additional compensation based on the second results received in response to the second request for information.

9. The method of locating patent assets according to claim 4, wherein the second request for information includes determining whether a patent asset is potentially for sale.

10. A method of locating patent assets comprising:
requesting, via a host website, information identifying patent assets from a research community over a network;
receiving, via the host website, the information from the research community pertaining to the request for information;
gathering, via the host website, the information;
weighting, via the one or more computers, the patent assets identified in the information; and
displaying, via the one or more computers or the host website, the patent assets sorted by the weighting.

11. The method of locating patent assets according to claim 10, wherein the weighting comprises a relevance factor showing the relevance of a patent assets.

12. The method of locating patent assets according to claim 11, wherein the relevance factor comprises one or more of the following indications: whether patent assets are identified multiple times, whether a patent-asset owner is amenable to selling respective patent assets; whether the patent assets are owned by certain types of patent-asset owners in industry sectors; whether the patent assets are owned by certain market valuation, industry sector companies, universities, individual inventors, large practicing entities, or NPEs; whether the patent assets can be commercialized within a predetermined period of time; whether the technology subject matter is currently commercialized; and whether the technology subject matter will be commercialized within one year, two years, three-five years, or any combination of a time.

13. The method of locating patent assets according to claim 11, wherein the weighting comprises determining the size of the entity owning the patent asset.

14. The method of locating patent assets according to claim 10 further comprising paying a commission to one or more research community members based on a fee received by a crowd-sourced platform administrator.

15. The method of locating patent assets according to claim 10 further comprising paying a flat fee to one or more research community members based on when results were returned relative to other results.

16. The method of locating patent assets according to claim 10 further comprising:
requesting, via the host website, second information from the research community over the network.

17. The method of locating patent assets according to claim 16 further comprising paying a commission to one or more research community members based on receiving second results received in response to the second request for information.

18. The method of locating patent assets according to claim 16 further comprising paying a commission to one or more research community members based on a fee received by a crowd-sourced platform administrator.

19. The method of locating patent assets according to claim 16 further comprising paying a flat fee to one or more research community members based on when results were returned relative to other results.

20. The method of locating patent assets according to claim 18 or 19 further comprising paying additional compensation based on the second results received in response to the second request for information.

21. The method of locating patent assets according to claim 16, wherein the second request for information includes determining whether a patent asset is potentially for sale.

22. A non-transitory computer-readable storage medium storing instructions for locating patent assets, the instructions causing one or more computer processors to perform operations comprising:
requesting information related to a technology subject matter, the request for information being accessible to a research community over a network;
receiving first results from the research community pertaining to the request for information;
gathering the first results;
performing a semantic request for the information, thereby obtaining second results;
comparing the first results with the second results; and
identifying results in the first results that are not in the second results.
